(19) United States
(12) Patent Application Publication
(10) Pub. No.: US 2010/0114748 A1
(43) Pub. Date: May 6, 2010

(54) Predictive advisor system and method for communicating with a user regarding a payment account in a computer network

(75) Inventors: Michael T. Duke, Monroe, NC (US); Leigh Ferrante, Charlotte, NC (US)

Correspondence Address: Wells Fargo;c/o K& L Gates, Hearst Tower, 47th Floor, 214 North Tryon Street, Charlotte, NC, 28202, US

(73) Assignee: Wachovia Corporation, Charlotte, NC (US)

(21) Appl. No.: 12/291,435

(22) Filed: Nov. 10, 2008

Related U.S. Application Data
(60) Provisional application No. 61/197,871, filed on Oct. 31, 2008.

(51) Int. Cl. G06Q 40/00

(52) U.S. Cl. 705/35

(57) ABSTRACT

A networked computer system for communicating with a user about spending associated with a payment account of the user. The system comprises a user, a payment account of the user, a web interface for communicating with the user, and a predictive advisor system. The predictive advisor system comprises a predictive advisor engine for monitoring spending activity related to the payment account and for providing financial and savings advice to the user via the web interface.

### CROSS-REFERENCE TO RELATED APPLICATIONS

This application claims the benefit of U.S. provisional patent application entitled PREDICTIVE ADVISOR filed on Oct. 31, 2008, herein incorporated by reference.

### FIELD OF THE INVENTION

The present invention relates generally to the field of electronic commerce and banking, particularly to a system and method for communicating with a user in a computer network to predict and to advise on spending associated with a payment account.

### BACKGROUND OF THE INVENTION

In today's ever increasing world of e-commerce and electronic banking, consumers of financial services and products are constantly searching for methods of disbursing and handling their funds that are both easy to use and convenient. As a result, with the prevalence of methods that permit easy access to funds and spending of funds, consumers are finding it increasingly difficult to maintain adequate funds in their accounts. It has also become increasingly more difficult to ensure that enough money is saved each month to advance consumers to their ultimate financial goals, whether that is retirement or the purchase of a car, a house, or even a vacation. Consumers are also concerned about the rise of identity theft and other electronic methods of fraudulently accessing one's funds. As a result, there is a demand in the market for a product that permits the consumer easy access to his or her funds electronically and also provides him or her advice electronically on how to spend but still reach financial goals, while guarding against identity theft and fraudulent access to the consumer's financial account.

### SUMMARY OF THE INVENTION

The present invention relates to a system and method for communicating with a user in a computer-based network about spending activity associated with a payment account of a user as well as a system and method to predict and to advise the user on spending patterns associated with a payment account of the user. The system, referred to herein as a predictive advisor system, is particularly suitable to be operated by a financial institution and the user of the system preferably is a customer of the financial institution. However, other variations of the system and method are within the scope of the present invention.

The system of the present invention operates in a networked computer environment for communicating with a user about spending associated with a payment account of the user. The system generally comprises a user, a payment account of the user, a web interface for communicating with the user, and a predictive advisor system. The predictive advisor system comprises a predictive advisor engine for monitoring spending activity related to the payment account and for providing financial and savings advice to the user via the web interface.

The method of the present invention is for monitoring a payment account of a user and to predict and to advise on spending activity related to the payment account. The method comprises enrolling a user in the computer-based predictive advisor system; obtaining account information about a payment account of the user to communicatively connect the payment account to the predictive advisor system so as to provide the predictive advisor system access to the payment account in a computer-based network; inputting spending information related to the payment account into the predictive advisor system based upon pre-determined spending categories or based upon individualized spending categories created by the user; setting a rule, a goal, or a combination thereof for the user in the predictive advisor system; monitoring by predictive advisor system spending activity associated with the payment account of the user; and notifying the user via a web interface when the rule is broken, when the goal is met, or when within a range of the rule being broken or the goal being reached.

The system of the present invention has various features for monitoring, tracking, messaging, predicting, and advising a user of the system regarding spending activity of the user, set forth in detail herein.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a drawing illustrating the overall environment in which the computer-based system and method of the present invention operates.

FIG. 2A is a drawing illustrating an aspect of the present invention in which a financial institution that is a payment account holder of the user comprises the predictive advisor system that operates in accordance with the present invention.

FIG. 2B is a drawing illustrating another aspect of the present invention in which the financial institution that comprises the predictive advisor system that operates in accordance with the present invention is not the payment account holder of the user.

FIG. 3 is a flowchart illustrating the method by which the predictive advisor system of the present invention operates.

FIG. 4 is a flowchart illustrating representative methodology of the predictive advisor engine of the predictive advisor system of the present invention.

### DETAILED DESCRIPTION OF THE INVENTION

The following detailed description of the embodiment(s) is merely exemplary in nature and is in no way intended to limit the invention, its application, or uses. The present invention will now be described fully hereinafter with reference to the accompanying drawings, in which preferred embodiments of the invention are shown. This invention, however, may be embodied in different forms and should not be construed as being limited to the preferred embodiments set forth herein. Rather, these preferred embodiments are provided so that this disclosure will be thorough and complete, and will fully convey the scope of the invention to those skilled in the art.

The present invention is directed to a system and method for communicating with a user in a computer-based network about spending activity associated with a payment account of the user as well as a system and method to predict and to advise the user on spending patterns associated with a payment account(s) of the user. Preferably, the user is a customer of a financial institution. It is contemplated that the system and method of the present invention would be beneficial for use by any financial institution including, but without limitation, a bank, credit union, savings and loan, or other entity that provides financial services, products or information. Additionally, it is contemplated that the system and method of the present invention would be equally beneficial, for example, for retail or other industries. The following description is provided herein solely by way of example for purposes of providing an enabling disclosure of the invention, but does not limit the scope or substance of the invention.

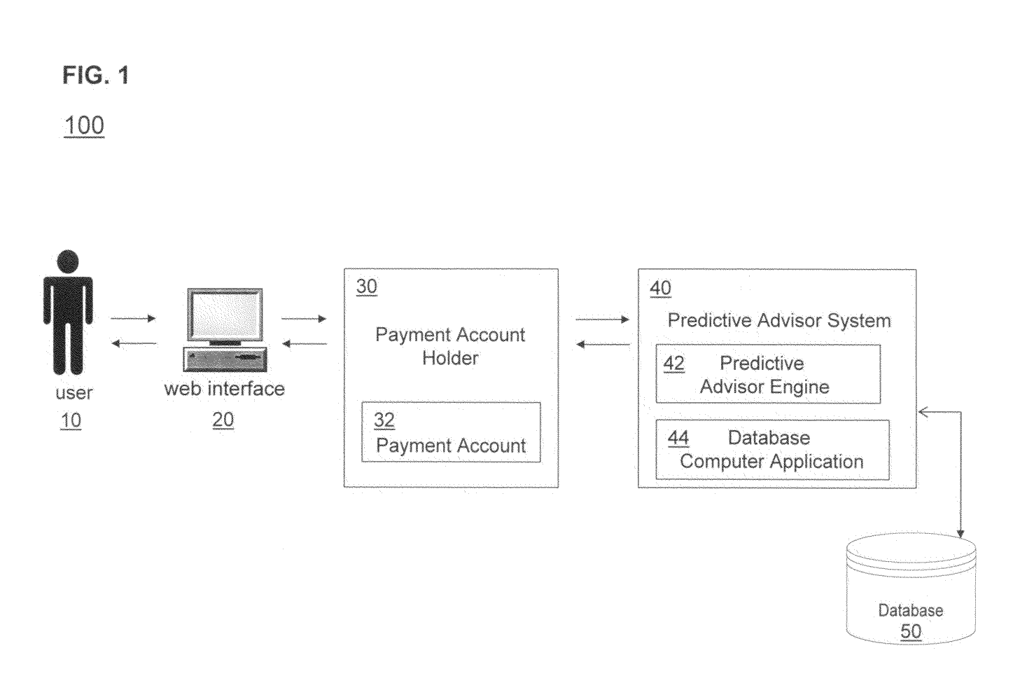

Referring now to the Figures, FIG. 1 is a drawing illustrating the overall environment in which the computer-based system and method of the present invention operates.

The networked computer system 100 of the present invention generally comprises a user 10, a web interface 20 for communicating with the user 10 a payment account holder 30, a payment account 32, and a computer-based predictive advisor system 40. Examples of a web interface 20 include, but are not limited to, a computer, personal data assistant, mobile device, automated-teller machine (ATM), netbook, or any other device that has connectivity to the internet or the world wide web. The predictive advisor system 40 comprises a predictive advisor computer engine 42. The predictive advisor engine comprises at least one of a computer-implemented rule, trend, option, goal and warning. The predictive advisor system further comprises a database computer application 44 for communicating with a database 50 for storing information and data. A “payment account,” as used herein refers to any account upon which funds can be drawn. Examples of payment accounts include, but are not limited to, stored-value accounts and financial accounts associated with a financial institution such as, but not limited to, a checking account or a savings account.

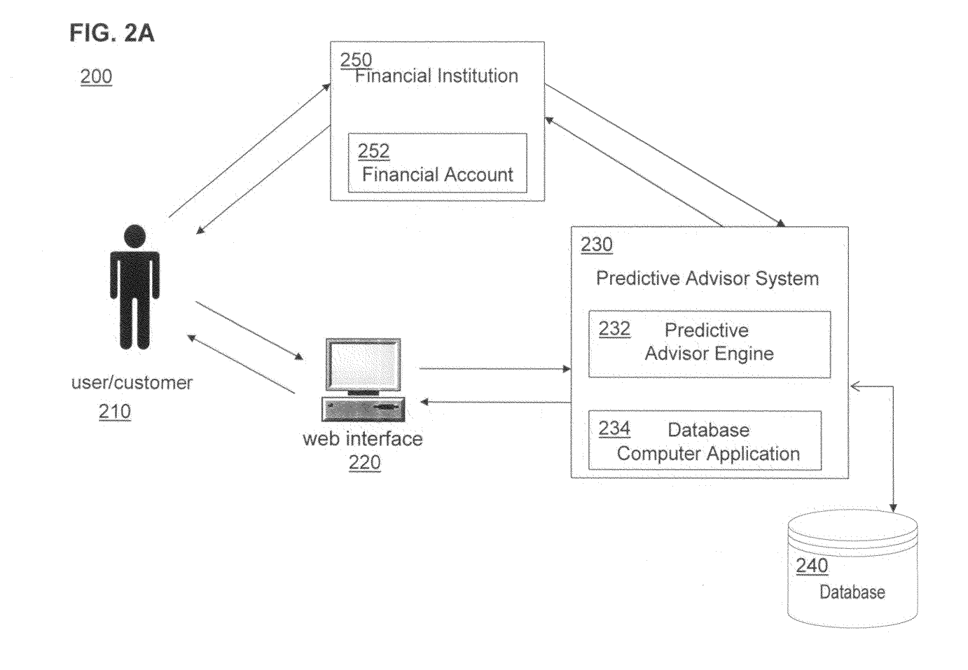

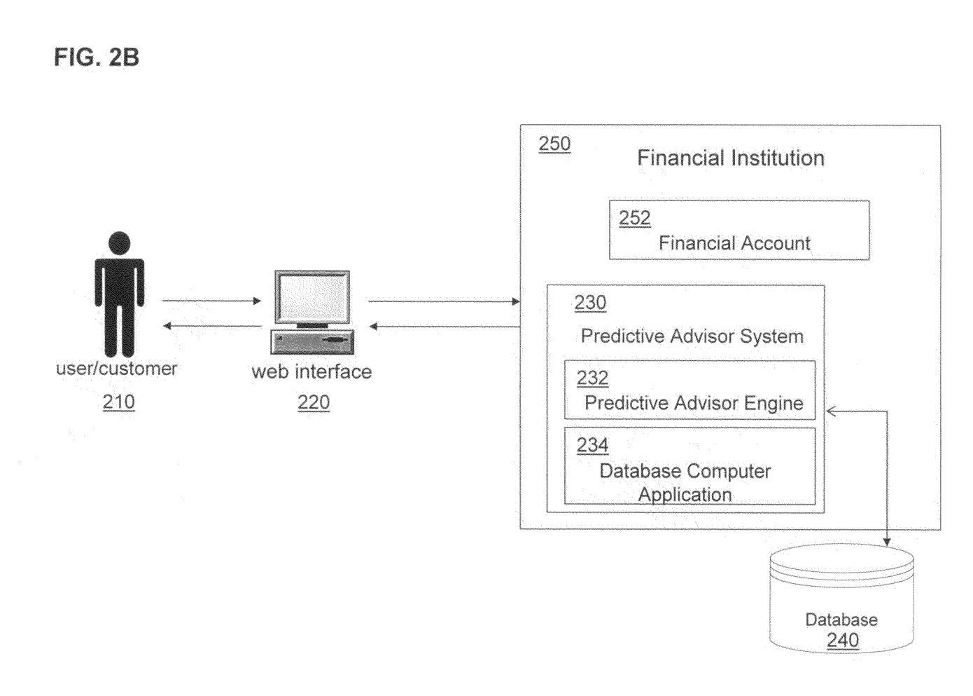

In a preferred aspect of the present invention, the payment account holder is a financial institution. Referring to the figures, FIG. 2A is a drawing illustrating an aspect of the present invention in which a financial institution that is a financial account holder of the user comprises the predictive advisor system operating in accordance with the present invention. As shown in FIG. 2A, user 210 is a customer of a financial institution 250 and has a financial account 252 with the financial institution 250. The user 210, having been enrolled in the computer-based service of the predictive advisor system 230 of the present invention, is communicatively connected with the predictive advisor system 230. The predictive advisor computer system 230 of the present invention may or may not be operated by the same financial institution that is also the holder of the financial account. As shown in FIG. 2A, the predictive advisor system is operated outside of the financial institution 250 that holds the financial account 252 of the user 210 even though the predictive advisor system 230 is communicatively connected to the financial institution 250 in the computer-based network. For example, the predictive advisor system 230 may reside on the server of another financial institution. The predictive advisor system 230 comprises a predictive advisor engine 232 and a database computer application 234 for communicating with the database 240 that is used for storing data and information of the user 210. The predictive advisor system 230 comprises a predictive advisor engine 232 and a database computer application 234 for communicating with the database 240 that is used for storing data and information of the user 210. The predictive advisor system 230 communicatively communicates with the user via a web interface 220 in order to predict and to advise the user 210 on spending associated with its financial accounts.

In another preferred aspect of the present invention, the predictive advisor system is operated by a financial institution. More preferably, the financial institution that is the financial account holder is also the financial institution that comprises the predictive advisor system. FIG. 2B is a drawing illustrating the aspect of the present invention in which the financial institution that comprises the predictive advisor system that operates in accordance with the present invention is not the financial institution that is the financial account holder of the user.

As shown in FIG. 2B, the financial institution 250 that is the holder of the financial account 252 of the user 210 also comprises the predictive advisor system 230 of the present invention. The predictive advisor system 230 comprises the predictive advisor engine 232. As shown in FIG. 2B, the user 210 is communicatively connected to the financial institution and, thus, the predictive advisor system 230. The predictive advisor system 230 provides advice and information to the user 210 by communicating in the computer-based environment via a web interface 220.

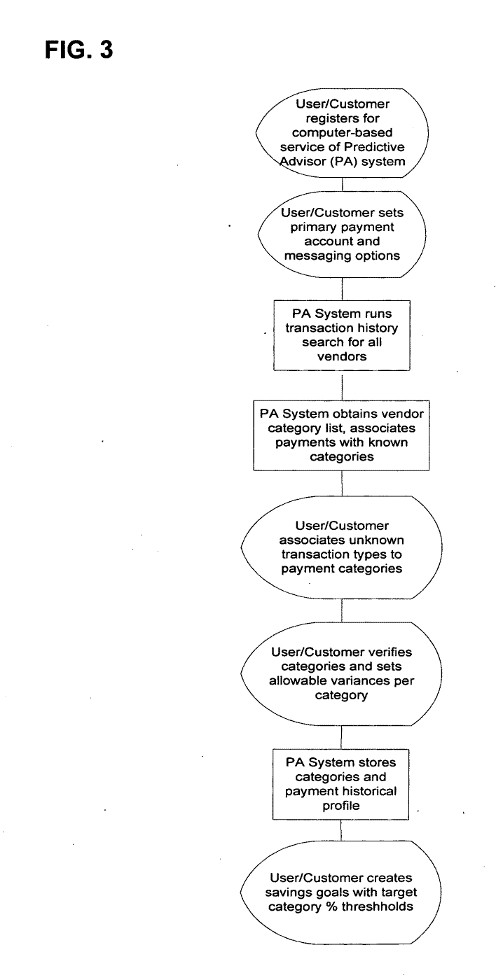

FIG. 3 is a flowchart illustrating the method by which the predictive advisor system of the present invention operates. As shown in FIG. 3, the user registers or enrolls by any method of communication including, but not limited to, by telephone, in person, or online on the internet, for the computer-based service to be provided by the predictive advisor system. A user either self-registers or a representative takes the information of the user and enters it into a computer database. During registration, the user selects a payment account, preferably a financial account, of the user to function as a primary payment account from which the predictive advisor system monitors activity related to the payment account of the user and provides financial and savings advice to the user via a web interface in the computer network. After the primary account is selected, the user is prompted to set messaging options using the web based interface. The messaging options include, but are not limited to, selection of the mode by which the messages are to be sent such as text message, e-mail, automated voice message, and the like, as well as the frequency at which the messages are sent by the predictive advisor system to the user.

The predictive advisor system generates a transaction history from the primary payment account of the user. The historical analysis is stored in a database with a primary key associated with the financial profile of the user. This transaction history creates a comprehensive list of the transactions made from this account and a vendor category list. The comprehensive transaction history can extend back as far as the user wishes, but a preferred embodiment will cap the transaction history at twelve months. From this history, the predictive advisor system collates the payments and associates these payments to the vendors. In addition, the predictive advisor system notes periodic payments for the necessary time period (for example, yearly, monthly, weekly, daily). If the vendor and its line of business is known to the predictive advisor system (for example, residing in the system's database), the predictive advisor system assigns the payments to one of the system's pre-determined payment categories. Payments made to unknown vendors or to vendors whose line of business is not known to the predictive advisor system are provided to the user for review. The user then reviews the listed transactions and either associates the unknown transactions to the pre-determined payment categories or creates new payment categories for the transactions.

For example, the transactions are categorized into pre-set default groupings or headings such as housing, entertainment, and food. In addition, as stated above, the user optionally customizes his or her categories into specialized groupings or headings. Thus, the user designates into which category each of the monthly expenditures of the user would fall. For example, the user could state that a payment of $1,500 on the ninth day of each month to a bank would constitute a “housing” payment.

Following the assignment of the periodic transactions, the predictive advisor system generates a list of the categories and payments and provides them to the user for review and verification. Additionally, the user assigns percentages of monthly income to be spent on each of the categories as well as sets allowable variances for the same. These rules set either a stated monetary amount or a percentage of a month's income that the user wishes to spend each month (or alternate time period chosen by the customer) on each category.

For example, a set of rules may be 25% housing, 15% entertainment, 15% food, 15% savings, 25% bills, and 5% for miscellaneous expenditures. Further, in addition to creating such categories wholesale, the user may import categories from online bill pay options, if the user is already a customer of such services. The predictive advisor system stores the categories and other assignments made by the user and with this information in a computer database, generates a historical profile referred to herein as a rule set. The user creates savings goals for the predictive advisor system evaluate using the predictive advisor engine of the predictive advisor system.

Therefore, in addition to charting and organizing monthly payments, the present invention allows the user to also input financial goals for the system to consider. If, for example, a user wanted to save $5,000 for a new car, he or she would enter that into the database as a goal and would also enter the time period he or she envisions having to accomplish that goal. The system, at the request of the user, generates a recommendation report based upon the time period selected by the user for the user to reach that goal. For example, the system could suggest that entertainment and miscellaneous expenditures be reduced by a percentage such as 5% and 2%, respectively, in order to reach the stated goal in a period of time.

The user has the option to adjust his or her rule set to adopt the suggestion of the predictive advisor system. If the stated goal was unobtainable given the time allowed for raising the funds and the amounts of money available for use, the predictive advisor system notifies the user accordingly and recommends either that the timeline, the goal, or the rules be altered, or that the user seek additional funds such as through a raise, loan or other source.

The predictive advisor system of the present invention has various features. In addition to the feature of suggesting solutions for the posed goals of a user, the predictive advisor system has the feature to transmit messages to the user. Such messages may notify the user that pre-arranged transactions have been successful or that the rules of a user are near being met or not being met. Additionally, the predictive advisor system optionally comprises fraud prevention features. For example, the predictive advisor system may notify the user typically by transmitted messages of a potential fraudulent access to his or her primary payment account via the user's mode of choice. The predictive advisor system notes the size of the transaction as well as the frequency in which transactions have been entered into with the recipient. For example, if a large transaction was occurring between the user's account and a recipient with whom he or she had never dealt, a warning would be sent in accordance with the systems' fraud thresholds to ascertain whether the transaction should be permitted. In addition, if a response to the warning is not received within a pre-set amount of time, the predictive advisor system automatically notifies the account holder of the user that a fraudulent transaction is or is expected to be occurring, thereby permitting the account holder's fraud department to possibly stop the transaction before funds depart the primary account of the user. The predictive advisor system also sends a notice if potentially duplicative payments are made. Another feature of the predictive advisor system is to notify the user if a typical or regular payment is in jeopardy of being missed. For example, if the user always pays $1,000 a month in child support by the fifteenth day of the month, and no such payment has been made, the predictive advisor system notifies the user of such upcoming payment deadline has been missed.

Another feature of the system of the present invention is that a user optionally sets rules regarding notifications and requests that the financial institution of the user, for example through its fraud department, is notified immediately if a transaction is attempted or occurs over a certain amount or a certain percentage of funds is withdrawn from the primary account.

In accordance with the present invention, the predictive advisor system through its predictive advisor engine sends messages and reminders about its proposed solutions to financial goals. The predictive advisor engine also notifies the user when he or she has purchased outside of those accepted solutions. In addition to warning messages and reminders, a feature of the predictive advisor system is to send a message when a savings goal is reached.

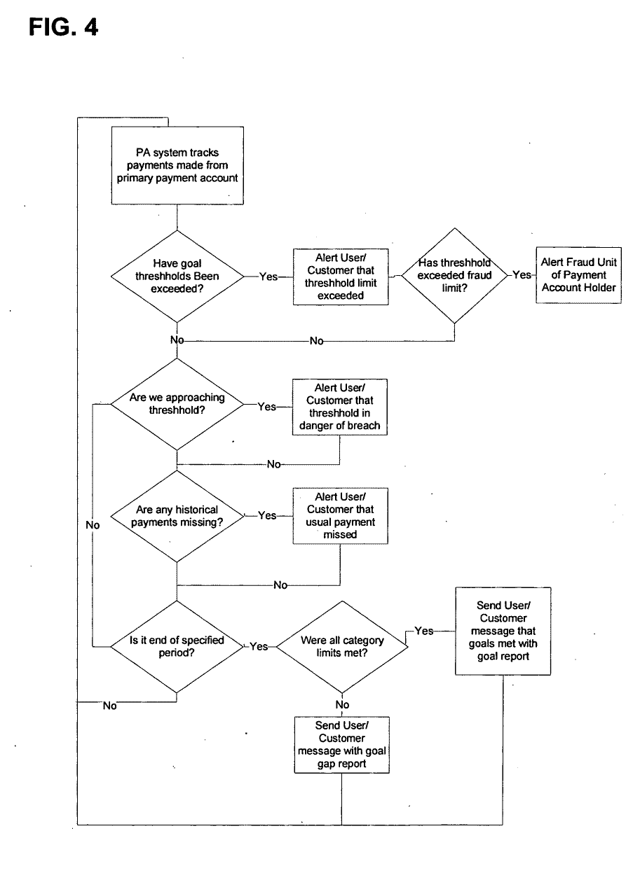

FIG. 4 is a flowchart illustrating representative methodology of the predictive advisor engine of the predictive advisor system of the present invention. Referring to FIG. 4, once the user is registered for predictive advisor system, the engine tracks or monitors payments made from the primary payment account. For example, the engine monitors payments made on a category by category level. Once a transaction has been concluded, the predictive advisor engine assigns the payment to a category. The engine queries whether the transaction causes a goal or rule threshold to be exceeded. If the answer is yes, the predictive advisor engine notifies the user that one or more thresholds have been exceeded and informs the user as to the breached thresholds. The system also evaluates whether the fraud threshold set by a user has been breached. If so, a feature of the system is to automatically notify of potential fraud, for example, to a fraud unit of the payment account holder of the user.

If no goal thresholds have been breached, the predictive advisor engine considers whether the transaction results in an impending breach. For example, the predictive advisor system evaluates whether the transaction brings a user within a specified percentage or range of the goal threshold. The percentage is adjustable by the user. If, for example, the user is within a set percentage, then the predictive advisor system notifies the user accordingly.

The engine also monitors the primary payment account for missing historical or regular periodic payments. If a usual payment has been missed, the predictive advisor system notifies the user of the missed payment with a reminder.

If at the end of the specified period such as at the end of the month, the predictive advisor system determines if all the category limits were met for the month. For example, if the stated savings goal has been met the user receives a message indicating such information. If not, the user is advised as to how he or she breached the stated savings goal such as with a goal gap report and the engine provides a readjusted savings strategy to make up for the shortfall. The user may also request the system to generate a recommendation as to how to curtail spending of the user or to change the spending habits of the user.

The predictive advisor system continues to track payments made from the primary payment account.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A networked computer system for communicating with a user about spending associated with a payment account of the user, the system comprising:
a user;
a payment account of the user;
a web interface for communicating with the user, and
a predictive advisor system comprising a predictive advisor engine for monitoring spending activity related to the payment account and for providing financial and savings advice to the user via the web interface.

2. The system according to claim 1, further comprising a database for storing data related to the payment account of the user.

3. The system according to claim 1, further comprising a database computer application.

4. The system according to claim 1, wherein the predictive advisor engine comprises at least one of a computer-implemented rule, trend, option, goal or warning related to the spending activity associated with the payment account of the user.

5. The system according to claim 1, wherein the payment account is a stored-value account, a financial account, or a combination thereof.

6. The system according to claim 1, wherein the web interface is a computer, a personal data assistant, a mobile device, a netbook, or an automated-teller machine (ATM).

7. A networked computer system for communicating with a user about a financial account of the user and spending activity associated with the financial account of the user, said system comprising:
a user; and
a financial institution comprising a financial account of the user and a predictive advisor system, wherein the predictive advisor system comprises a predictive advisor engine for monitoring spending activity related to the financial account and for providing financial and savings advice to the user via a web interface in the networked computer system.

8. The system according to claim 7, wherein the predictive advisor engine comprises at least one of a computer-implemented rule, trend, option, goal or warning related to the spending activity associated with the payment account of the user.

9. The system according to claim 7, wherein the payment account is a stored-value account, a financial account, or a combination thereof.

10. The system according to claim 7, wherein the web interface is a computer, a personal data assistant, a mobile device, a netbook, or an automated-teller machine (ATM).

11. A method for monitoring a payment account of a user and advising on spending activity related to the payment account, the method comprising:
enrolling a user in a computer-based predictive advisor system;
obtaining account information about a payment account of the user to communicatively connect the payment account to the predictive advisor system so as to provide the predictive advisor system access to the payment account in a computer-based network;
inputting spending information related to the payment account into the predictive advisor system based upon pre-determined spending categories or based upon individualized spending categories created by the user;
setting a rule, a goal, or a combination thereof for the user in the predictive advisor system;
monitoring by predictive advisor system spending activity associated with the payment account of the user; and
notifying the user via a web interface when the rule is broken, when the goal is met, or when within a range of the rule being broken or the goal being reached.

12. The method according to claim 11, wherein the payment account is a financial account.

13. The method according to claim 12, wherein the payment account is held by a financial institution.

14. The method according to claim 13, wherein the financial institution that holds the financial account also monitors the spending activity associated with the payment account of the user in the predictive advisor system.

15. The method according to claim 14, wherein the financial institution notifies the user via a web interface when the rule is broken, when the goal is met, or when within a range of the rule being broken or the goal being reached.

16. The method according to claim 11, wherein the user is notified by instant messaging, telephone, e-mail, or a combination thereof.

17. The method according to claim 11, wherein an additional notification is requested by the user through the web interface.

18. The method according to claim 17, wherein the additional notification is in response to a user request for a status update of the payment account relative to the rule or goal.

19. The method according to claim 11, further comprising monitoring potential fraudulent activity associated with the spending activity associated with the payment account.

20. The method according to claim 19, further comprising notifying by the predictive advisor system the user upon detection of potential fraudulent activity.

21. The method according to claim 20, wherein the notification is provided to the user via the web-interface.

22. The method according to claim 19, further comprising notifying a fraud department responsible for overseeing the payment account of the user.

23. The method according to claim 11, further comprising responding by the predictive advisor system to a request by the user to predict financial status of the user after a pre-determined amount of time.

24. The method according to claim 11, further comprising responding by the predictive advisor system to a request by the user to generate a recommendation as to how to change spending patterns of the user.

25. The method according to claim 11, further comprising responding by the predictive advisor system to a request by the user to generate a recommendation as to how to increase savings of the user.

26. The method according to claim 11, further comprising monitoring by the predictive advisor system for a missing historical or regular periodic payment.

27. The method according to claim 14, wherein the user is a customer of the financial institution.
